(19) United States
(12) Patent Application Publication
(10) Pub. No.: US 2019/0193335 A1
(43) Pub. Date: Jun. 27, 2019

(54) METHOD OF FABRICATING A THREE-DIMENSIONAL OBJECT WITH REMOVABLE SUPPORT STRUCTURE

(71) Applicant: Rize, Inc., Woburn, MA (US)

(72) Inventors: Eugene Giller, Wellesley, MA (US); Nathalie P. O'Hara, Bedford, MA (US); Thomas Davidson, Lexington, MA (US)

(21) Appl. No.: 16/329,711

(22) PCT Filed: Jul. 14, 2017
(86) PCT No.: PCT/US17/42223

§ 371 Date: Feb. 28, 2019

Related U.S. Application Data
(60) Provisional application No. 62/381,300, filed on Aug. 30, 2016.

(51) Int. Cl. B29C 64/40; B29C 64/118

(52) U.S. Cl. CPC B29C 64/40; B29C 64/393; B29C 64/118

(57) ABSTRACT

A fabrication process for producing three-dimensional objects and removable support structures. The removal of the support structure from the object is facilitated by the deposition of a release agent or a release layer between the object and the support structure. The removal of the support structure may be further facilitated by applying forced cooling, filament density adjustments, or changes in deposition pressure to the object and/or the support structure during fabrication.

### RELATED APPLICATIONS

This application claims priority to and the benefit of U.S. Provisional Application No. 62/381,300, filed Aug. 30, 2016. The entire teachings of the above application are incorporated herein by reference.

### BACKGROUND OF THE INVENTION

With the increased use of Computer Aided Design (CAD) solid modeling systems, a new frontier of manufacturing technology has emerged that enables translation of the CAD output data into a three-dimensional physical object. This technology is commonly referred to as additive manufacturing (e.g., solid freeform fabrication or layer manufacturing), which entails building an object on a layer-by-layer and point-by-point basis. Examples of commercially available solid freeform fabrication systems include stereo lithography, selective laser sintering, laminated object manufacturing, and fused deposition modeling. Other examples of solid freeform fabrication systems are known to those of skill in the art.

Forming objects automatically in three dimensions is useful in verifying CAD databases, assessing aesthetics, checking ergonomics of design, aiding in tool and fixture design, creating conceptual models and sales/marketing tools, generating patterns for investment casting, reducing or eliminating engineering changes in production, and providing small production runs.

During the additive manufacturing process, it can be both time and labor consuming to remove a support structure constructed during the manufacturing process. -Various methods for removing the support structure include breaking the support, dissolving the support material in liquid media, or melting away the support material. These methods can result in imperfections on the surface of the part. In addition, parts may require post-processing, such as winding or polishing.

### SUMMARY OF THE INVENTION

It would be desirable to provide a three-dimensional manufacturing method and apparatus that are able to produce a variety of three-dimensional objects that are easily removable from a support without requiring any additional post-processing. Aspects of the invention are directed to fabrication of such three-dimensional objects. The three-dimensional objects may have high-resolution color.

Disclosed herein are three-dimensional fabrication methods comprising (a) virtually identifying an area of a three-dimensional object that requires a support structure (e.g., using a processor); (b) virtually generating a support structure for the three-dimensional object (e.g., using a processor); (c) virtually slicing a scene that includes the support structure and the three-dimensional object into layers (e.g., using a processor); (d) identifying an area of each layer where the support structure is adjacent to the three-dimensional object (e.g., using a processor); (e) depositing a polymer layer of a support structure and/or an object (e.g., using a printing apparatus); (f) depositing a layer comprising a release agent on at least a portion of the polymer layer of the support structure or the object (e.g., using a printing apparatus); and (g) depositing at least one polymer layer of a three-dimensional object and/or the support structure onto the layer comprising the release agent (e.g., using a printing apparatus).

In certain aspects, the release agent is an ink deposited through at least one print head of an apparatus. In certain embodiments, the release agent is formulated with materials selected from the group consisting of silicone oils, oil and hydrocarbons, polyethylene glycol, polypropylene glycols, esters, surfactants, water soluble gums, solid release matter in plasticizer or volatile solvent, low tack adhesive, and combinations thereof. The release agent may be selected based on a non-reactive chemistry, a reactive chemistry or phase-change materials.

In certain embodiments, the identified area between the three.-dimensional object and the support structure is converted into a two-dimensional image file. In some aspects, the support structure is formed from a polymeric material, and wherein the support structure polymeric material is similar to or the same as a polymeric material used to form the three-dimensional object. In other aspects, the support structure is formed from a polymeric material, and wherein the support structure polymeric material is different from a polymeric material used to form the three-dimensional object.

In certain aspects, the support structure has an external ink layer, and wherein the external ink layer includes at least one ingredient that is soluble in the polymeric material that forms the three-dimensional object.

In accordance with certain aspects of the present invention, the at least one ingredient of the external ink layer may accelerate dissolution of the polymeric material of the support structure.

In some aspects, a virtual space is generated during the slicing of the scene between the support structure and the three-dimensional object. A thickness of the space may be between 0.1% and 100% of the polymer layer thickness. Alternatively, a thickness of the space is about 50% of the polymer layer thickness. The thickness of the space may be adjusted based on curvature of the three-dim en sional object.

In certain embodiments, filament density of the support structure, the three-dimensional object, or the support structure and the three-dimensional object is adjusted during the three-dimensional fabrication process. The filament density variations may be within 0.5 to 1.7 of nominal filament density.

In some aspects, at least one of the polymer layers of the three-dimensional object and/or the support structure are forced cooled prior to deposition of the layer comprising the release agent. The at least one of the polymer layers may be forced cooled by applying ambient or outside air or by applying compressed gas.

In certain aspects, the three-dimensional object is formed using fused deposition modeling. In some embodiments, the layer comprising the release agent includes ultraviolet absorbing dyes or fluorescent dyes. In some aspects, the layer comprising the release agent is deposited between the three-dimensional object and the support structure at the identified areas where the support structure is adjacent to the three-dimensional object. The concentration of the release agent may be adjusted based on curvature of the three-dimensional object.

Also disclosed herein are three-dimensional fabrication methods comprising (a) forming a three-dimensional object, and (b) during the formation of the three-dimensional object, forming a support structure adjacent to the three-dimensional object, wherein a layer comprising a release agent is deposited between the three-dimensional object and the support structure (e.g., by use of a three-dimensional printer).

Also disclosed herein are three-dimensional fabrication methods comprising (a) forming a three-dimensional object; and (b) during the formation of the three-dimensional object, forming a support structure adjacent to the three-dimensional object, wherein forced cooling is applied to at least one external polymer layer of the support structure and/or the three-dimensional object (e.g., by use of a three-dimensional printer).

Also disclosed are three-dimensional fabrication methods comprising (a) forming a three-dimensional object; and (b) during the formation of the three-dimensional object, forming a support structure adjacent to the three-dimensional object, wherein a layer comprising a release agent is deposited between the three-dimensional object and the support structure, and wherein the release agent prevent adhesion between two subsequent layers of polymer (e.g., by use of a three-dimensional printer).

Also disclosed herein are articles of manufacture comprising a three-dimensionally printed object having an external polymer layer; a three-dimensionally printed support structure having an external polymer layer; and a layer comprising a release agent deposited between the external polymer layer of the three-dimensional object and the external polymer layer of the support structure.

The above discussed, and many other features and attendant advantages of the present inventions will become better understood by reference to the following detailed description of the invention. Furthermore, it is to be understood that the features of the various embodiments described here are not mutually exclusive and can exist in various combinations and permutations.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the invention. In the following description, various embodiments of the present invention are described with reference to the following drawings, in which:

FIG. 1 depicts a schematic configuration of a prior art Filament Deposition Modeling apparatus;

FIG. 2 depicts a schematic configuration of a fabrication apparatus according to a known process;

FIG. 3 depicts a schematic configuration of a fabrication process according to an aspect of the present invention;

FIG. 4A-4D depicts a schematic representation of a three-dimensional object adjacent a support structure. The figures are generated using three-dimensional printing software. FIG. 4A shows a stair step three-dimensional object. FIG. 4B shows a support structure for the three-dimensional object adjacent to the three-dimensional object. The support structure may be automatically generated using the software. FIG. 4C shows the bitmap of the release layer (yellow). During fabrication, a release agent is deposited in the designated location. FIG. 4D shows the release agent layer covered by a layer of polymer (in pink);

FIG. 5 depicts a schematic representation of the slicing of a three-dimensional object and support structure into layers. The support structure (dotted grey area) is built underneath the three-dimensional object (solid blue area) in required areas. The three-dimensional printing software slices vertically the supported three-dimensional object (i.e., the three-dimensional object and the support structure) into layers having a height equal to one nominal polymer layer height. Where the software detects that the three-dimensional object is in contact with the support structure, the software creates an additional space between the two polymer layers of the support structure and the object. That space will be equal to X, and the slice will thus have a height of 1+X;

FIG. 6 provides a flowchart depicting a three-dimensional fabrication process for producing a three-dimensional object with a removable support structure; and

FIG. 7 is a diagrammatic illustration of a high level architecture for implementing processes in accordance with aspects of the invention.

The patent or application the contains at least one drawing executed in color. Copies of this patent or patent application publication with color drawings will he provided by the Office upon request and payment of the necessary fee.

### DETAILED DESCRIPTION OF THE INVENTION

It is desirable to provide a three-dimensional manufacturing method and apparatus that are able to produce a variety of three-dimensional objects that are easily removable from a support structure. In accordance with some aspects of the present invention, a release layer or a layer comprising a release agent is deposited between a fabricated three-dimensional object and a support structure. A virtual space between a three-dimensional object and a support structure can be generated using three-dimensional fabrication software and that space may be enlarged or reduced prior to depositing a release layer within the identified space during fabrication. Filament density of a polymer used to form a three-dimensional object and/or a support structure may be adjusted (e.g., lowered or increased) relative to a nominal filament density. External polymer layer(s) of a three.-dimensional object and/or a support structure may be forced cooled.

In accordance with further aspects of the present invention, one or more of the described methods may be combined to improve releasability of a three-dimensional object from a support structure. For example, a release layer may he deposited between the support structure and the three-dimensional object. Alternatively, a release layer may be deposited between the support structure and the three-dimensional object, and additionally at least one polymer layer of the three-dimensional object and/or the support structure may be forced cooled. A release layer can be deposited between the support structure and the three-dimensional object, and the filament density of the polymer used to form the object and/or the support structure is adjusted relative to a nominal filament density. Features and advantages of some or all of the support structure removal methods disclosed here will be apparent to those who are skilled in the art given the benefit of the following summary and description of exemplary, non-limiting examples.

As used herein; “three-dimensional fabrication” is used to refer to the method of building a three-dimensional object and/or support structure layer-by-layer. Three-dimensional fabrication refers to the combination of depositing at least one layer of a polymer and printing at least one layer of an ink to form a three-dimensional object. A polymer or ink layer is formed by at least one pass of a deposition apparatus or a printing apparatus, one, two, three, four, five or more passes. The number of passes may be dependent on the desired dots per inch (dpi). The at least one polymer layer and at least one ink layer may be deposited and printed in any order, depending on the desired structures and outcome; however, introduction of a release layer between two polymer layers should result in a bifurcation between two bodies along which they will be separable (e.g., a support structure and a three-dimensional object). For example, multiple polymer layers may be deposited prior to an ink layer being printed. In some examples, the polymer and ink layers alternate by individual or multiple layers. Various three-dimensional fabrication methods are known in the art, including, but not limited to, fused deposition modeling, laminated object manufacturing, stereo lithography, and selective laser sintering.

Various three-dimensional deposition or fabrication apparatuses may be used to perform the described fabrication method in conjunction with aspects of the present invention to result in innovative advancements described herein. Generally, a three-dimensional fabrication apparatus utilized herein includes a deposition apparatus and a printing apparatus. In some embodiments, the deposition apparatus is similar to that used for fused deposition modeling. In some embodiments, the printing apparatus is paired with any solid free-form fabrication apparatus that builds three-dimensional polymer objects by utilizing a layer-by-layer build process. Non-limiting examples of such apparatuses include a laminated object manufacturing apparatus or a three-dimensional photopolymer apparatus.

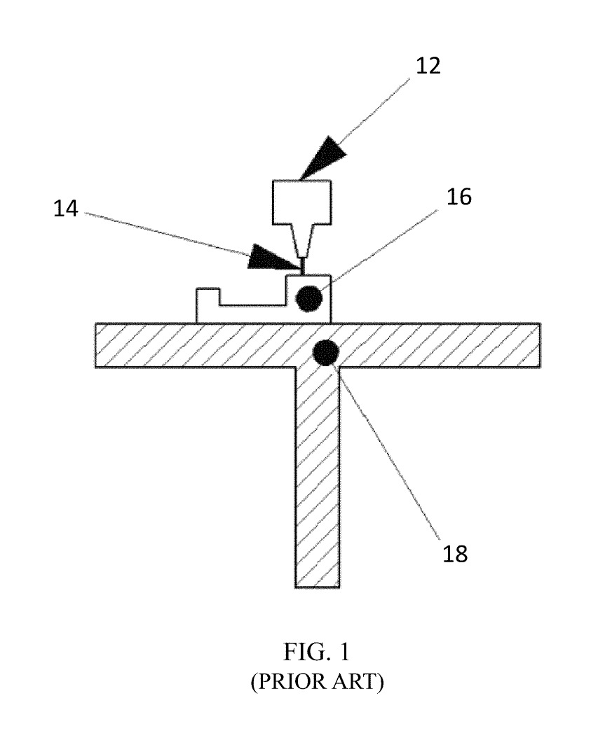

One example of a known fused deposition modeling apparatus is shown in FIG. 1. Extruder assembly 12 dispenses polymer 14 onto build platform 18, in a layer-by-layer process, to form three-dimensional object 16. Once three-dimensional object 16 is completed it may be removed from build platform 18 and a new project may begin.

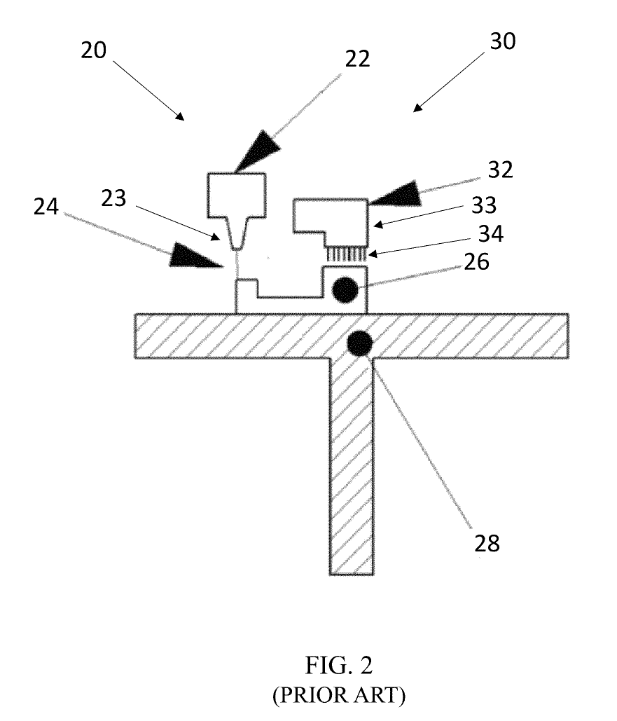

An example of another three-dimensional fabrication apparatus is described in U.S. Pat. No. 9,227,366, which is incorporated herein by reference in its entirety. A schematic of this three-dimensional fabrication apparatus is provided in FIG. 2. The apparatus includes a deposition apparatus 20 similar to that used for fused deposition modeling and a printing apparatus 30 having a print head and ink delivery system 32. The three-dimensional fabrication apparatus includes extruder assembly 22 that dispenses polymeric material 24, in a layer-by-layer process, to form three-dimensional object 26 on build platform 28. In addition, the fabrication apparatus includes print head and ink delivery system 32, which dispenses ink on three-dimensional object 26, in a layer-by-layer process, during the build process.

A deposition apparatus 20 includes an extruder assembly 22 that dispenses a polymer 24. The extruder assembly 22 may include one or more extruder heads 23 for dispensing one or more polymeric materials 24 (e.g., polymers). In some aspects, the polymeric material 24 forms a three-dimensional object 26 in a layer-by-layer process on a build platform 28.

The printing apparatus 30 includes a print head and ink delivery system 32 for depositing an ink 34 during production of any three-dimensional object 26 using the three-dimensional fabrication apparatus. The printing apparatus 30 may include one or more print heads 33 for dispensing one or more inks 34. The print head and ink delivery system 32 may deposit the ink 34 in a layer-by'-layer fashion during the fabrication process.

The printing apparatus 30 having the print head and ink delivery system 32 is attached to the same mechanism as the deposition apparatus 20 having the extruder assembly 22, such that it travels with the deposition apparatus 20. In some embodiments, the printing apparatus 30 is attached to an independent moving or stationary mechanism that is attached to the three-dimensional fabrication apparatus. In still other embodiments, the printing apparatus 30 is aligned with the deposition apparatus 20, but not attached to the deposition apparatus 20.

The printing apparatus 30 includes a print head(s) 33 that is, for example, a piezoelectric print head, a thermal print head, a MEMS print head, an electrostatic print head, or combinations thereof. In some aspects, the printing apparatus 30 includes a print head 33 that is a plotter type single nozzle unit, a continuous ink jet, or a drop on demand system. In certain aspects, one or more print heads 33 are included within the printing apparatus 30. In other aspects, a print head 33 includes one or more channels. In some embodiments, the printing apparatus 30 utilizes a jetting deposition method. Alternatively, the printing apparatus 30 utilizes a deposition method that is not jetting. For example, the printing apparatus 30 may include an extrusion nozzle, such as for release agent deposition, a sprayer, brushing or capillary tubing.

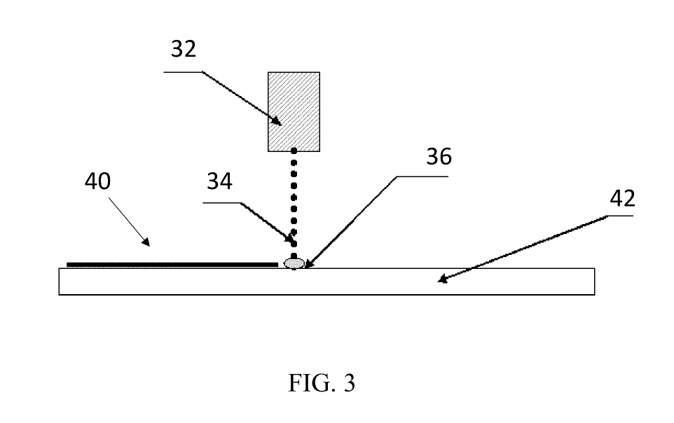

An example of a three-dimensional fabrication method for producing a three-dimensional object 50 and/or support structure 52 is provided herein. A three-dimensional fabrication method may include depositing a first polymer layer 42, printing a first ink layer 40 on to the first polymer layer 42, depositing a second polymer layer 42 on to the first ink layer 40, and printing a second ink layer 40 on to the second polymer layer 42. The second ink layer 40 may comprise the same ink as that used in the first ink layer 40. In some embodiments, the fabrication process is repeated until a completed three-dimensional object 50 is formed. A schematic demonstrating a three-dimensional fabrication process is provided in FIG. 3, showing an ink layer 40 being formed on a polymer layer 42 by having print head and ink delivery system 32 deposit ink 34 droplets, optionally including dyes on to polymer layer 42. Ink 34 droplets form interaction area 36 where the ink contacts polymer layer 42. In alternative fabrication methods, a polymer layer 42 is deposited, and the process of depositing polymer layer 42 is repeated until a completed three-dimensional object 50 is formed.

The first and second polymer layers 42 may each include a plurality of polymer layers 42. The plurality of polymer layers 42 forming a first (or second) polymer layer 42 need not all be formed of the same polymeric material 24, but may include one or more distinct polymeric materials 24. The first and second ink layers 40 may each include a plurality of ink layers 40. The plurality of ink layers 40 forming a first (or second) ink layer 40 need not all be formed of the same ink 34, but may include one or more distinct inks 34. In certain embodiments, the polymer layers 42 and ink layers 40 are deposited in varying number and in varying order when fabricating a three-dimensional object 50 and/or support structure 52 in accordance with the invention as later described herein. Further, the polymer layers 42 and/or the ink layers 40 need not extend completely over the previously deposited layer. In sonic instances, an ink layer 40 is deposited only over a portion of the previously deposited polymer (or ink) layer 42.

In certain embodiments, a polymer layer 42 is deposited completely prior to an ink layer 40 being printed onto the polymer layer 42. In some embodiments, while the polymeric material 24 is in the process of being deposited, an ink layer 40 is printed onto the same polymer layer 42. In some embodiments, a first portion of at least one ink layer 40 includes a first ink 34 and a second portion of the at least one ink layer 40 includes a second ink 34. In certain embodiments, a first portion of at least one polymer layer 42 includes a first polymeric material 24 and a second portion of the at least one polymer 42 layer includes a second polymeric material 24.

At least one of the polymer layers 42 may include a polymeric material 24, such as, for example, acrylonitrile butadiene styrene (“ABS”), polyacrylates, polyolefins, cyclic olefin polymers and copolymers, polycarbonates, polyamides, polyimides, polyethylene and polybutylene terephthalate, liquid crystal polymer resins (“LCP”), polyether ether ketone (“PEEK”), thermoplastic elastomers (“TPE”), polystyrenes, polyvinyl chloride, polysulfones, polyacrylates, polyurethanes, polyamides, polyesters, polyolefins, epoxy resins, silicon resin, a diallyl phthalate resin, a cellulosic plastic, a rosin-modified maleic acid resin, copolymers thereof, any other macromolecular structure, and combinations thereof. In certain aspects, the polymeric material 24 is acrylonitrile butadiene styrene. In some aspects, the polymer layer 42 includes a biocompatible or biodegradable polymeric material, such as, for example, collagen, elastin, hydrogels, xerogels, proteins, peptides, or a combination of any of them. In some embodiments, the polymer layer 42 includes a synthetic polymer, such as, for example, polycaprolatone (“PCL”), poly(D,L,-lactide-co-glycolide) (“PLGA”), polyactide (“PLA”), poly(lactide-co-caprolactone) (“PLCL”), or a combination of any of them. In certain aspects, the polymeric material 24 is supplemented with one or more ingredients, such as inorganic or organic filler, adhesives, plasticizers, coloring agents (e.g., dyes or pigments), functional fillers or combinations thereof.

In certain embodiments the first polymer layer 42 is wetted by application of the first ink layer 40. In some aspects, the ink of the first ink layer 40 contains a plasticizer. The ink may be diffused into the first polymer layer(s) 42. To obtain improved wetting characteristics, the polymer and ink layers 42, 40 may be treated with plasma or corona discharge. In some embodiments, the layers are treated by passing the source of the discharge above the surface of the layers at, for example, a 1-5 mm distance.

In accordance with illustrative embodiments of the present invention, an ink 34, such as a releasing ink, is utilized to aid in releasing a support structure 52 from an object 50. The basic deposition process as described above can be modified to include a releasing ink in accordance with the below description to advance the technology and result in a support structure 52 and an object 50 separable therefrom. In some embodiments, a releasing ink 34 provides a shell on an object 50. In some aspects, the releasing inks further include, for example, dyes, or catalysts to be utilized in forming the shell.

In certain embodiments, a support structure 52 is formed adjacent to, or attached to, an object 50 during the three-dimensional fabrication process. In some aspects, the object 50 is formed from a polymeric material 24. In some embodiments, the deposition apparatus is used to form the support structure 52. Alternatively, a second deposition apparatus may be used to form the support structure 52.

The polymeric material 24 of the support structure 52 may be similar to, or in some embodiments is the same as, a polymeric material 24 used to form the object 50. The polymeric material 24 of the support structure 52 may be similar to the polymeric material 24 of the object 50, when the polymeric material 24 of the support structure is the same as the polymeric material 24 used to form the object 50, but includes a supplemental ingredient, or vice versa. In other embodiments, a polymeric material 24 of the support structure 52 is different than the polymeric material 24 used to form the object 50. The support structure 52 and/or the object 50 may be formed of one or more polymeric materials 24. In some aspects, the support structure 52 includes a polymeric material 24 that is a water soluble, solvent soluble, or alkali soluble polymer, such as, for example water soluble wax, polyethylene oxide and glycol-based polymers, polyvinyl pyrrolidone-based polymers, methyl vinyl ether, or maleic acid-based polymers.

In some embodiments, the support structure 52 has an external ink layer 40. In certain embodiments, the external ink layer 40 includes at least one ingredient that is soluble in a polymeric material 24 included in the support structure 52. The ingredient in the ink layer 40 may accelerate dissolution of the polymeric material 24. In some aspects, the at least one ingredient is a low molecular weight compound, such as, polyethylene glycols, polypropylene glycols, polyalkylene glycols, or polyethylene oxide.

In some embodiments, in addition to the at least one ingredient that is soluble in the polymeric material 24, the ink layer contains at least one ingredient that forms a film on the surface of the polymer layer 42. In some aspects, the at least one ingredient is a salt such as potassium chloride, potassium oxalate, or sodium citrate, low molecular weight water soluble polymers such as polyvinyl alcohols, or polyethylene oxides or water soluble organic compounds such as dimethyl urea, or propylene glycol.

The support structure 52 may be removable from the object 50, and in some examples may be broken into smaller pieces for removal. Some methods for removing the support structure 52 from the object 50 are described herein.

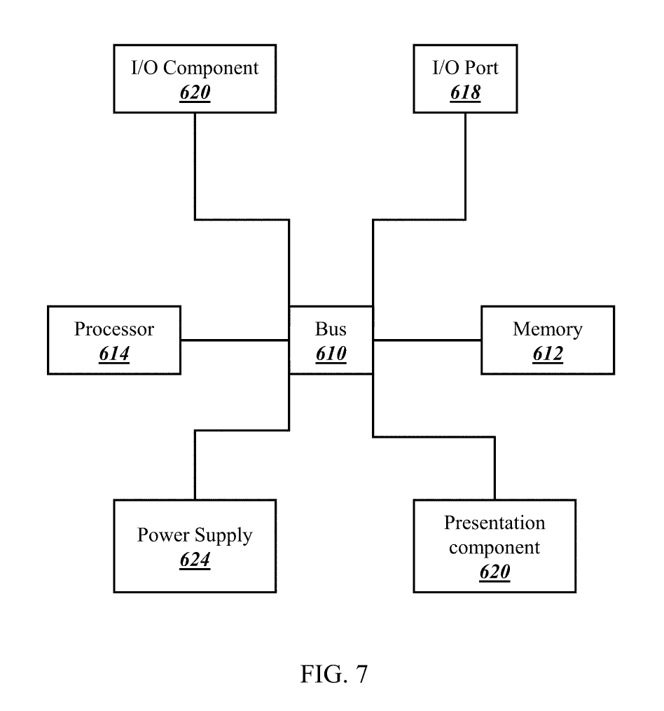

A method for fabricating an object 50 and support structure 52, wherein the support structure 52 is removable, may include using a software program, such as file preparation software for three-dimensional printing. The software may be used to perform or assist in the performance of various steps of the fabrication method, operating on suitable computer hardware having the necessary processing capabilities as would be readily understood by those of skill in the art. FIG. 7 depicts an illustrative suitable computing device 600 that can be used to implement the computing methods/functionality described herein and be converted to a specific system for performing the operations and features described herein through modification of hardware, software, and firmware, in a manner significantly more than mere execution of software on a generic computing device, as would be appreciated by those of skill in the art. One illustrative example of such a computing device 600 is depicted in FIG. 7. The computing device 600 is merely an illustrative example of a suitable computing environment and in no way limits the scope of the present invention A “computing device,” as represented by FIG. 7, can include a “workstation,” a “server,” a “laptop,” a “desktop,” a “hand-held device,” a “mobile device,” a “tablet computer,” or other computing devices, as would be understood by those of skill in the art. Given that the computing device 600 is depicted for illustrative purposes, embodiments of the present invention may utilize any number of computing devices 600 in any number of different ways to implement a single embodiment of the present invention. Accordingly, embodiments of the present invention are not limited to a single computing device 600, as would be appreciated by one with skill in the art, nor are they limited to a single type of implementation or configuration of the example computing device 600.

The computing device 600 can include a bus 610 that can be coupled to one or more of the following illustrative components, directly or indirectly: a memory 612, one or more processors 614, one or more presentation components 616, input/output ports 618, input/output components 620, and a power supply 624. One of skill in the art will appreciate that the bus 610 can include one or more busses, such as an address bus, a data bus, or any combination thereof. One of skill in the art additionally will appreciate that, depending on the intended applications and uses of a particular embodiment, multiple of these components can be implemented by a single device. Similarly, in some instances, a single component can be implemented by multiple devices. As such, FIG. 7 is merely illustrative of an exemplary computing device that can be used to implement one or more embodiments of the present invention, and in no way limits the invention.

The computing device 600 can include or interact with a variety of computer-readable media. For example, computer-readable media can include Random Access Memory (RAM); Read Only Memory (ROM); Electronically Erasable Programmable Read Only Memory (EEPROM); flash memory or other memory technologies; CDROM, digital versatile disks (DVD) or other optical or holographic media; magnetic cassettes, magnetic tape, magnetic disk storage or other magnetic storage devices that can be used to encode information and can be accessed by the computing device 600.

The memory 612 can include computer-storage media in the form of volatile and/or nonvolatile memory. The memory 612 may be removable, non-removable, or any combination thereof. Exemplary hardware devices are devices such as hard drives, solid-state memory, optical-disc drives, and the like. The computing device 600 can include one or more processors that read data from components such as the memory 612, the various 110 components 616, etc. Presentation component(s) 616 present data indications to a user or other device. Exemplary presentation components include a display device, speaker, printing component, vibrating component, etc.

The I/O ports 618 can enable the computing device 600 to be logically coupled to other devices, such as I/O components 620. Some of the I/O components 620 can be built into the computing device 600. Examples of such I/O components 620 include a microphone, joystick, recording device, game pad, satellite dish, scanner; printer, wireless device, networking device, and the like.

Turning back to the method of the present invention, for example, the software, operating on such computing device 600 having one or more processors 614, may be used to identify an area of the object 50 that requires support, design or virtually generate the support structure 52 is virtually slice a scene, and/or identify an area of each layer where the support structure 52 is adjacent to the object 50. The three-dimensional fabrication method using the file preparation software may include identifying an area of an object 50 that requires a support structure 52 (step 200), virtually generating a support structure 52 for the object 50 (step 202), virtually slicing a scene that includes the support structure 52 and the object 50 into layers (step 204), identifying an area of each layer where the support structure 52 is adjacent to the object 50 (step 206), and relying on the virtual design created by the software, instructing the depositing of polymer layer(s) 42 of the support structure 52 and/or the object 50 (steps 208 and 212) and/or a release layer 54 formed by a releasable ink. In such embodiments, the fabrication method includes depositing the release layer 54 (e.g., a layer comprising a release agent) between the polymer layer 42 of the object 50 and the polymer layer 42 of the support structure 52 (step 210) where the support structure 52 is identified as being adjacent to the object 50 during the fabrication process (see FIG. 6).

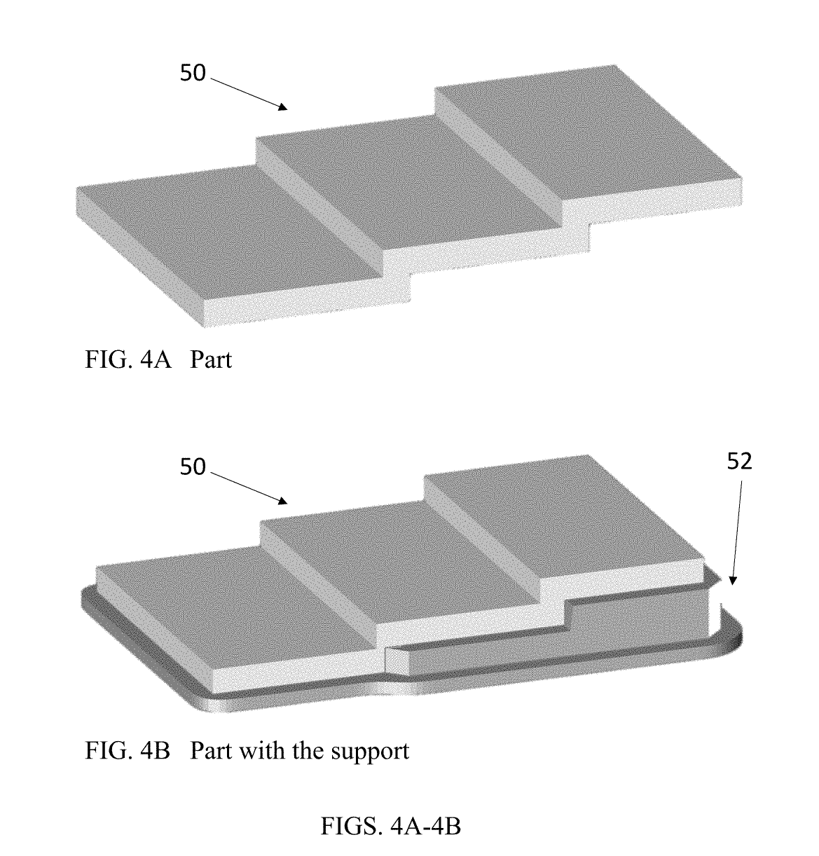

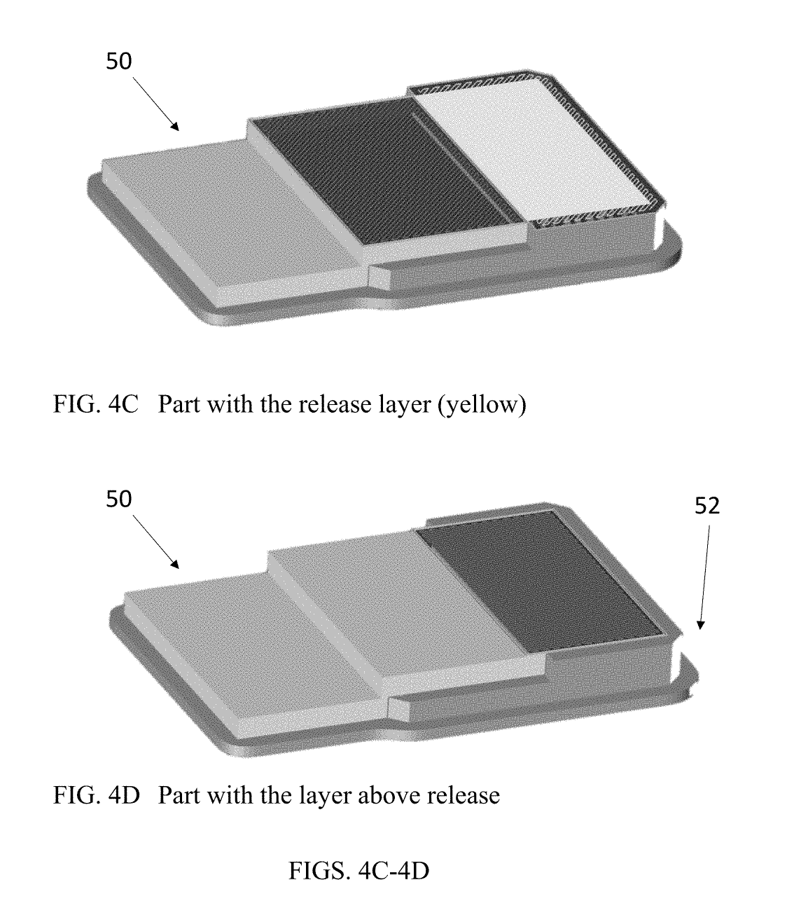

The fabrication of a three-dimensional object 50 with a removable support structure 52 is depicted in FIG. 4. As seen in FIG. 4A a three-dimensional object 50 is fabricated (as utilized herein interchangeably, “object” and “three-dimensional object” refer to the three-dimensional object that is the focus of the fabrication process). A support structure 52 may be fabricated adjacent to the object 50 (FIG. 4B). In some examples, a release layer 54 may be deposited between the support structure 52 and the object 50 (FIGS. 4C-4D). FIG. 4C provides a bitmap of the release layer 54 (yellow) that identifies where the release layer will be deposited during fabrication. The release layer 54 is then covered by another layer of polymeric material 24 as the object 50 is fabricated.

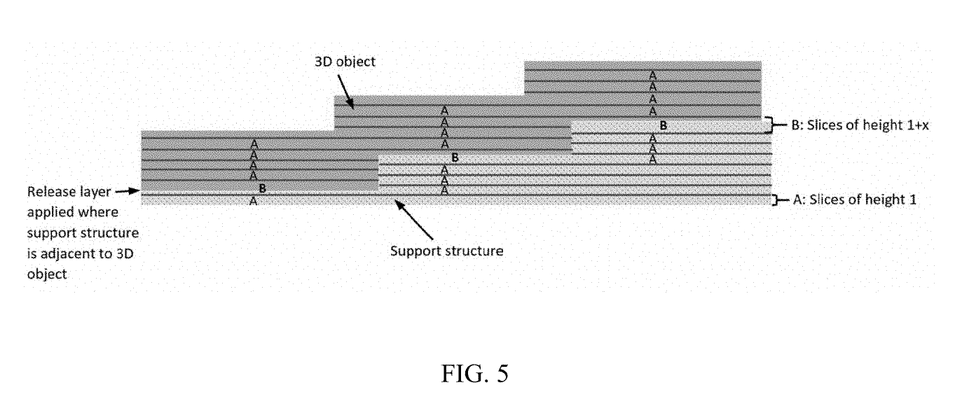

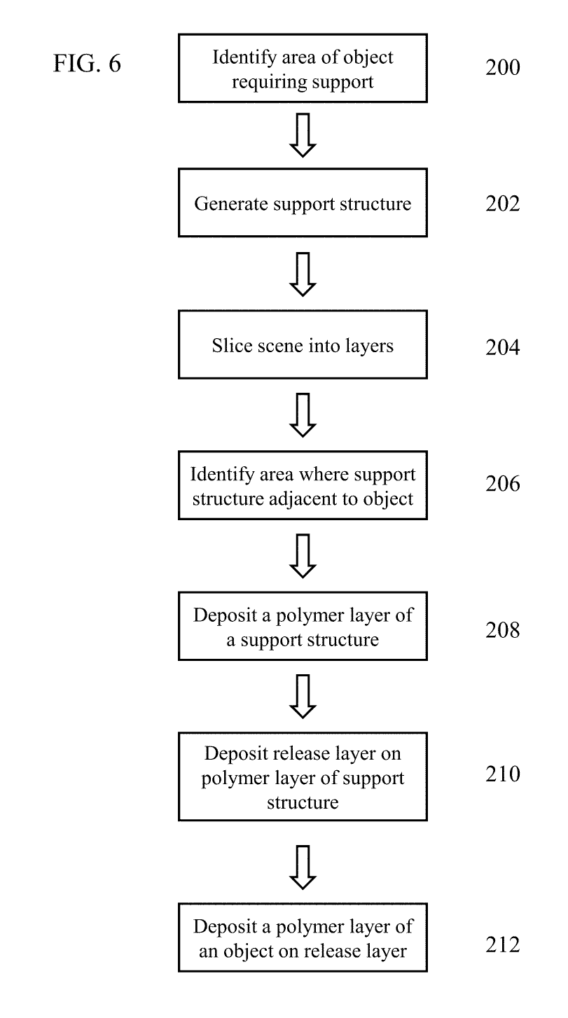

A schematic demonstrating the use of the file preparation software is provided in FIG. 5. For example, a support structure 52 (dotted grey area) is virtually built or generated beneath an object 50 (solid blue area). The software may be used to virtually vertically slice the supported object 50 (i.e., the object 50 and the support structure 52) into layers 56 having a height equal to one nominal polymer layer height. Where the software detects that the object 50 is in contact with the support structure 52, the software can create additional space x and a virtual space 58 becomes x+1 between the polymer layers 42 of the support structure 52 and the object 50. The space is equal to x, and the slice prepared by the software will have a height of 1+x. During the three-dimensional deposition process, a release agent or release layer 54 may he deposited in the space designated as x, and the filament density of the polymer layers 42 may be adjusted as needed. The adjustment of the filament density occurs so that no physical gap exists once the object 50 is built. The release agent may contact both the external layer of the support structure 52 and the external layer of the object 50, forming a thin release layer 54 that separates the two polymer layers 42 and prevents adhesion of the two polymer layers 42.

In certain embodiments, a release layer 54 (also referred to herein as a release agent layer) is deposited between the object 50 and the support structure 52. The release layer 54 may be deposited on the object 50, the support structure 52, or both the object 50 and the support structure 52. In certain embodiments, the release layer 54 is deposited on the support structure 52. In some embodiments, the release layer 54 is deposited only at the location where the support structure 52 is attached and/or adjacent to the object 50.

In certain embodiments, a polymer layer 42 forming a support structure 52 is deposited completely prior to a release layer 54 being deposited onto the polymer layer 42 of the support structure 52. A polymer layer 42 forming an object 50 may then be deposited on a release layer 54 once the release layer 54 is deposited completely. In some embodiments, while the polymeric material 24 is in the process of being deposited, a release layer 54 is printed onto the polymer layer 42 of the support structure 52. In additional aspects, the polymeric material 24 forming a polymer layer 42 of an object 50 is deposited while the polymeric material 24 of the support structure 52 and the release layer 54 are being deposited. In other embodiments, a polymer layer 42 forming a support structure 52 is deposited and a polymer layer 42 forming an object 50 is deposited, without depositing a release layer 54 between the polymer layers 42. In still other aspects, a release layer 54 need not extend completely over the deposited polymer layer(s) 42. A release layer 54 may be deposited only over a portion of the previously deposited polymer layer 42.

The release agent utilized by the present invention may prevent adhesion between two subsequent layers of a polymeric material 24 (e.g., thermoplastic material). In some aspects, the release agent may be formulated with one or more materials. For example, the release agent may be formulated with materials selected from silicone oils, oil and/or hydrocarbons, polyethylene glycol, esters, surfactants, low tack adhesives, water soluble gums, solid release matter dissolved in a plasticizer or a volatile solvent, and combinations thereof.

The release agent may be selected based on a non-reactive chemistry, a reactive chemistry or phase-change materials. Phase-change refers to a material that transitions between solid, liquid and/or gas. For example, a phase-change release agent may transition from a liquid to a solid or from a solid to a liquid. The release agent material may be a liquid when above a certain temperature and is thus deposited in a liquid state. The material may then solidify upon cooling (e.g., a wax material). Reactive chemistry release agents may include a combination of two or more inks 34, where a chemical reaction would occur when the individual inks 34 are mixed and/or in contact with one another. The individual inks 34 would not be active on their own. One example of a reactive chemistry release agent is a two-part epoxy. Another example of a reactive chemistry release agent is a combination of two inks 34, with one ink 34 containing a catalyst that causes polymerization of the second ink 34 when the two inks 34 are in contact. In certain aspects, an ink 34 comprising a release agent selected based on its reactive chemistry is deposited from one or more print heads 33, or alternatively is deposited from a single print head 33 having multiple channels.

In some embodiments, a release layer 54 formed between a support structure 52 and an object 50 includes an ink 34, where the ink 34 includes a release agent. In other aspects, a release layer 54 formed between a support structure 52 and an object 50 includes a polymeric material 24, where the polymeric material 24 includes a release agent. In some aspects, the release agent is a low tack adhesive. A low tack adhesive provides low adhesive strength and a removable, non-permanent joint between two surfaces (e.g., the support structure 52 and the object 50). The bond formed by the adhesive may be maintained for only a short period of time, and may be removed and/or peeled off of the support structure 52 and/or the object 50 without causing any tear or damage to either surface. The removal of the adhesive also does not result in any tack or sticky residue remaining on the support structure 52 or the object 50.

In certain embodiments, a low-tack adhesive is fugitive glue, or E-Z release glue (e.g., the type of glue found on the back of direct mail marketing products or credit cards attached to a letter). Fugitive glue may be available in the form of a pressure sensitive, hot melt, water base. In some embodiments, a low-tack pressure sensitive adhesive, such as that found on post-it notes, is utilized. Such an adhesive may he easily removed without leaving a residue on the surface.

In some embodiments, a low-tack adhesive is dispensed from one or more print heads 33 as an ink 34 in liquid form. The adhesive may be jetted in its liquid form onto a support structure 52, thereby forming a weak bond between the support structure 52 and the object 50 printed adjacent the support structure 52. In some aspects, the low-tack system is dispensed as hot melt from an extruder head (e.g., an extruder head different than that used for dispensing a polymeric material 24 for fabrication of a support structure 52 and/or object 50). In some aspects, an object 50 is fabricated on top of a support structure 52 (e.g., resting on the support structure 52) that includes a jetted adhesive. The fabrication of the object 50 on the support structure 52 may cause the object 50 to exert light pressure on the support structure 52, thereby forming a temporary bond between the support structure 52 and the object 50. In sonic aspects, the object 50 is removable from the support structure 52 (e.g., due to the low-tack, weak adhesive nature of the bond).

In some embodiments, a release layer 54 formed between a support structure 52 and an object 50 includes an ink 34 that comprises a surfactant. A “surfactant” as used herein refers to a material that can change surface properties of the interface between two liquids, a solid and a liquid, or two solids. In general, each molecule of the surfactant contains hydrophilic and lipophilic ends. In some aspects, when a surfactant is deposited on a polymer layer 42 (e.g., a polymer surface) (e.g., by depositing an ink layer 40 containing a surfactant), the surfactant molecules orient themselves such that the lipophilic ends direct towards the surface of non-polar polymer and the hydrophilic ends direct towards the surface of polar polymers. Non-limiting examples of the type of surfactants that may he utilized in an ink include, ionic surfactants (e.g., cationic or anionic surfactants), non-ionic surfactants (e.g., sorbitan oleate emulsifier 80, polysorbate 80 polysorbate 60), or amphoteric surfactants, etc. In some embodiments, a release layer 54 formed between a support structure 52 and an object 50, where the release layer 54 includes a surfactant, allows for easy removal of the support structure 52 from the object 50.

During the initial steps of fabricating an object 50 with a removable support structure 52, a file preparation software may be used to create or virtually generate a space 58 (e.g., nominal polymer height plus space x) between the support structure and the three-dimensional object. The space 58 may be generated during the slicing of the scene. In some embodiments, the space 58 between the support structure 52 and the object 50 is between 0.1% and 100% of the polymer layer 42 thickness. In some embodiments, the space 58 between the support structure 52 and the object 50 is greater than 100% of the polymer layer 42 thickness. In some embodiments, the space 58 between the support structure 52 and the object 50 is about 5%, 10%, 20%, 25%, 30%, 40%, 50%, 60%, 70%, 75%, 80%, 90% or 95% of the polymer layer 42 thickness. In other embodiments, the space 58 between the support structure 52 and the object 50 is about 50% of the polymer layer 42 thickness. In some aspects, the space 58 is adjusted based on curvature of the object 50. It is generally understood that the pressure between an external layer of the support structure 52 and a first layer of the object 50 (or an external layer of the object 50 and a first layer of the support structure 52, where the support structure 52 is positioned above the object 50) may be reduced by increasing the space 58 between. the support structure 52 and the object 50. In contrast, the pressure may be increased if the space 58 is decreased.

In some aspects, a release layer 54 is deposited between the support structure 52 and the object 50. The release layer 54 may be deposited on the support structure 52, on the object 50, or on both the support structure 52 and the object 50. In some aspects, a space 58 is calculated and/or formed between the external polymer layer 42 of the support structure 52 and the object 50 using file preparation software (e.g., nominal polymer height plus space x). In some aspects, the identified space 58 is filled in part or in total with release layer 54 during fabrication of the object 50 with the removable support structure 52.

In some embodiments, the speed of deposition of the polymer 42 and/or release layers 54 is varied. In some aspects, the speed of deposition may be reduced or increased when transitioning from deposition of a polymer layer 42 to deposition of a release layer 54, or alternatively, from deposition of a release layer 54 to deposition of a polymer layer 42. In some aspects, a slower speed of deposition is utilized for small radius features, e.g., those features below 10 mm in size. In some aspects, a timing delay may be implemented between the deposition of polymer layers 42 and/or release layers 54.

In certain embodiments, filament density of the support structure 52 and/or the object 50 is adjusted or varied during fabrication. The term “filament density” is used herein to refer to the ratio of the volume of extruded material relative to the free volume of a standard layer. The free volume of the standard layer can be calculated as (width×length×height) of the standard layer (see FIG. 5A). In some aspects, the filament density variation is within 0.1 to 2 times the nominal filament density. In other aspects, the filament density is within 0.5 to 1.7 times the nominal filament density. The variation of the filament density of a polymeric material 24 may be dependent on the type of polymeric material 24. In some embodiments, the filament density of a polymer layer 42 adjacent to a release layer 54 is adjusted. For example, the filament density of an external polymer layer 42 of an object 50 may be varied within 0.5 to 1.7 times the nominal filament density of the polymer layer 42, where the external polymer layer 42 is adjacent to a release layer 54 deposited on a support structure 52. Alternatively or additionally, the filament density of an external polymer layer 42 of a support structure 52 may be varied within 0.5 to 1.7 times the nominal filament density of the polymer layer 42, where the external polymer layer 42 is adjacent to a release layer 54 deposited on an object 50. In some aspects, the filament density is adjusted based on curvature of the object 50 and/or on curvature of the support structure 52.

In some embodiments, fabrication of the object 50 and the support structure 52 includes deposition of polymer layers 42. The object 50 and/or the support structure 52 may include an external polymer layer 42. In some aspects, the external polymer layer 42 of the object 50 is forced cooled. In other aspects, the external polymer layer 42 of the support structure 52 is forced cooled. Alternatively, multiple polymer layers 42, or in some aspects all of the polymer-layers 42, forming a support structure 52 and/or an object 50 are forced cooled. Forced cooling may occur by blowing ambient or outside air on the polymer layer 42 or applying compressed air or gas to the polymer layer 42. In some aspects, a release layer 54 may be deposited between the external polymer layers 42 of the support structure 52 and the object 50. The external polymer layer 42 of the object 50 and/or the external polymer layer 42 of the support structure 52 may be forced cool prior to deposition of the release layer 54. In other aspects, the external polymer layer(s) 42 is cooled prior, during or after deposition of the release layer 54. In some aspects, the release layer 54 includes an ink with a high thermal conductivity or may contain components that partially or fully evaporate (e.g., be a cooling ink), and thereby cool the surface.

One skilled in the art readily appreciates that the present invention is well adapted to carry out the objects and obtain the ends and advantages mentioned, as well as those inherent therein. The details of the description and the examples herein are representative of certain embodiments, are exemplary, and are not intended as limitations on the scope of the invention. Modifications therein and other uses will occur to those skilled in the art. These modifications are encompassed within the spirit of the invention. It will be readily apparent to a person skilled in the art that varying substitutions and modifications may be made to the invention disclosed herein without departing from the scope and spirit of the invention.

The articles “a” and “an” as used herein in the specification and in the claims, unless clearly indicated to the contrary, should be understood to include the plural referents. Claims or descriptions that include “or” between one or more members of a group are considered satisfied if one, more than one, or all of the group members are present in, employed in, or otherwise relevant to a given product or process unless indicated to the contrary or otherwise evident from the context. The invention includes embodiments in which exactly one member of the group is present in, employed in, or otherwise relevant to a given product or process. The invention also includes embodiments in which more than one, or all of the group members are present in, employed in, or otherwise relevant to a given product or process. Furthermore, it is to be understood that the invention provides all variations, combinations, and permutations in which one or more limitations, elements, clauses, descriptive terms, etc., from one or more of the listed claims is introduced into another claim dependent on the same base claim (or, as relevant, any, other claim) unless otherwise indicated or unless it would be evident to one of ordinary skill in the art that a contradiction or inconsistency would arise. It is contemplated that all embodiments described herein are applicable to all different aspects of the invention where appropriate. It is also contemplated that any of the embodiments or aspects can be freely combined with one or more other such embodiments or aspects whenever appropriate. Where elements are presented as lists, e.g., in Markush group or similar format, it is to be understood that each subgroup of the elements is also disclosed, and any element(s) can be removed from the group. It should be understood that, in general, where the invention, or aspects of the invention, is/are referred to as comprising particular elements, features, etc., certain embodiments of the invention or aspects of the invention consist, or consist essentially of such elements, features, etc. For purposes of simplicity those embodiments have not in every case been specifically set forth in so many words herein. It should also be understood that any embodiment or aspect of the invention can be explicitly excluded from the claims, regardless of whether the specific exclusion is recited in the specification. For example, any one or more active agents, additives, ingredients, optional agents, types of organism, disorders, subjects, or combinations thereof, can be excluded.

Where the claims or description relate to a composition of matter, it is to be understood that methods of making or using the composition of matter according to any of the methods disclosed herein, and methods of using the composition of matter for any of the purposes disclosed herein are aspects of the invention, unless otherwise indicated or unless it would be evident to one of ordinary skill in the art that a contradiction or inconsistency would arise. Where the claims or description relate to a method, e.g., it is to be understood that methods of making compositions useful for performing the method, and products produced according to the method, are aspects of the invention, unless otherwise indicated or unless it would be evident to one of ordinary skill in the art that a contradiction or inconsistency would arise.

Where ranges are given herein, the invention includes embodiments in which the endpoints are included, embodiments in which both endpoints are excluded, and embodiments in which one endpoint is included and the other is excluded. It should be assumed that both endpoints are included unless indicated otherwise. Furthermore, it is to be understood that unless otherwise indicated or otherwise evident from the context and understanding of one of ordinary skill in the art, values that are expressed as ranges can assume any specific value or subrange within the stated ranges in different embodiments of the invention, to the tenth of the unit of the lower limit of the range, unless the context clearly dictates otherwise. It is also understood that where a series of numerical values is stated herein, the invention includes embodiments that relate analogously to any intervening value or range defined by any two values in the series, and that the lowest value may be taken as a minimum and the greatest value may be taken as a maximum. Numerical values, as used herein, include values expressed as percentages. For any embodiment of the invention in which a numerical value is prefaced by “about” or “approximately”, the invention includes an embodiment in which the exact value is recited. For any embodiment of the invention in which a numerical value is not prefaced by “about” or “approximately”, the invention includes an embodiment in which the value is prefaced by “about” or “approximately”.

As used herein “A and/or B”, where A and B are different claim terms, generally means at least one of A, B, or both A and B. For example, one sequence which is complementary to and/or hybridizes to another sequence includes (i) one sequence which is complementary to the other sequence even though the one sequence may not necessarily hybridize to the other sequence under all conditions, (ii one sequence which hybridizes to the other sequence even if the one sequence is not perfectly complementary to the other sequence, and (iii) sequences which are both complementary to and hybridize to the other sequence.

“Approximately” or “about” generally includes numbers that fall within a range of 1% or in some embodiments within a range of 5% of a number or in some embodiments within a range of 10% of a number in either direction (greater than or less than the number) unless otherwise stated or otherwise evident from the context (except where such number would impermissibly exceed 100% of a possible value). It should be understood that, unless clearly indicated to the contrary, in any methods claimed herein that include more than one act, the order of the acts of the method is not necessarily limited to the order in which the acts of the method are recited, but the invention includes embodiments in which the order is so limited. It should also be understood that unless otherwise indicated or evident from the context, any product or composition described herein may be considered “isolated”.

As used herein the term “comprising” or “comprises” is used in reference to compositions, methods, and respective component(s) thereof, that are essential to the invention, yet open to the inclusion of unspecified elements, whether essential or not.

As used herein the term “consisting essentially of” refers to those elements required for a given embodiment. The term permits the presence of additional elements that do not materially, affect the basic and novel or functional characteristic(s) of that embodiment of the invention.

The term “consisting of” refers to compositions, methods, and respective components thereof as described herein, which are exclusive of any element not recited in that description of the embodiment.

### EXAMPLES

The following non-limiting examples illustrate the preparation of inks of the present invention. These examples are only for illustrative purposes. It will he apparent to one skilled in the art that variations of each individual formula are possible. Other ink chemistries can be used to provide similar release benefits. Depending on the nature of the plastic filament, other classes of materials can be used as a release agent, such as, but not limited to: oil and/or hydrocarbons, esters, phase change inks, reactive inks, inks containing, a solid release matter dissolved in a plasticizer or volatile solvent, water soluble gums, inks containing a surfactant as releasing agent, and low tack systems such as a fugitive glue.

All tests were performed using Rize, Inc. three-dimensional printing machine prototypes constructed internally. The prototypes were equipped with a proprietary extruder head and one or more Ricoh Gen4 piezoelectric printheads. In addition, proprietary software and firmware were used for slicing of the CAD models and driving the printers.

All percentages listed in the Examples are expressed by weight.

### Example 1

### Low Viscosity Silicone Oil Based Ink

An ink containing 74% DMS-T05 polydimethylsiloxane (Gelest), 25% DMS-T21 polydimethylsiloxane. (Gelest) and 1% of a compatible liquid dye was prepared. The dye was added to provide visibility of the ink in the printing process and is not a required ingredient of the composition. All ingredients were added together and the mixture was stirred until homogenous. The mixture was then vacuum filtered through 1.0 micron glass fiber filter. The resulting ink had a viscosity of 13 cps at 20° C.

The ink was evaluated using Rize's alpha printer prototype with Topas 7010F-600 purchased from TOPAS Advanced Polymers, Inc. The ink offered good release properties on various geometries.

### Example 2

### High Viscosity Silicone Oil Based Ink

An ink containing 57.5% DMS-T05 polydimethylsiloxane, 40% DMS-T21 polydimethylsiloxane (Gelest), 2% DMS-T31 polydimethylsiloxane (Gelest) and 0.5% compatible liquid dye was prepared. The dye was added to provide visibility of the ink in the printing process and is not a required ingredient of the composition. All ingredients were added together and the mixture was stirred until homogenous. The mixture was then filtered through 1.0 micron glass fiber filter. The resulting ink had a viscosity of 24 cps at 22° C.

Jetting parameters of the printhead were adjusted in order to provide good and reliable jetting of the ink. The ink was evaluated using Rize's alpha printer prototype with Topas 7010F-600 purchased from TOPAS Advanced Polymers, Inc. The ink offered good release properties on various geometries.

### Example 3

### Polyethylene Glycol Based Ink

An ink containing 60% polyethylene gycol 400 (Sigma), 38% dipropylene glycol methyl ether (Spectrum Chemicals), 1% BYK333 surfactant (BYK Chemie) and 1% compatible liquid dye was prepared. The dye was added to provide visibility of the ink in the printing process and is not a required ingredient of the composition. The polyethylene glycol 400, dipropylene glycol methyl ether and surfactant were first added together and stirred until forming a homogenous solution. The dye was then added and the mixture was stirred until homogenous. The mixture was then filtered through 1.0 micron glass fiber filter. The resulting ink had a viscosity of 26 cps at 22° C.

The ink was evaluated using Rize's alpha printer prototype with Topas 7010E-600 purchased from TOPAS Advanced Polymers, Inc. The ink offered good release properties on various geometries.

Example 4

### Evaluation of Surfactant Inks

An ink containing 39.5% Dowanol PPh, 39.5% Dowanol TMP, 20.7% Span 80 and 0.3% compatible dye was prepared. The dye was added to provide visibility of the ink in the printing process and is not a required ingredient of the composition. All of the ingredients were added together and the mixture was stirred until homogenous. The mixture was then vacuum filtered through 1.0-micron glass fiber filter. The resulting ink had a viscosity of 17 cps at 20° C.

The ink was evaluated on Rize's printer prototype with filament produced from Topas 7010F-600 purchased from TOPAS Advanced Polymers, Inc. Multiple tests were performed to evaluate cooling effect and adjusting the layer height during the printing process.

First, a three steps stair structure was printed using ink saturation of two drops per pixel and 90 mm/second extruder speed. Some release was achieved on the first step and no release was achieved on the second and third steps.

Second, the first experiment was repeated, but the layer height was increased in the boundary region between the support and release layer by 50%. All the three steps released with some effort, but the surface of the layer above the release was not perfect.

Third, the second experiment was repeated, but used a delay of 10 seconds between depositing of the release ink layer and extruding the layer above release. This resulted in easy release and provides good surface.

Fourth, the second experiment was again repeated, but used a blower to cool the extruded layer during printing. No delay occurred between layers. The result was good release and good surface.

Fifth, the second experiment was repeated, but a release ink was not printed on the top of the support surface. No release was demonstrated on any layer.

Sixth, the fourth experiment was repeated to print a variety of complex parts. All the parts showed easy release and good surfaces on the areas of the part above the support.

Finally, numerous experiments were conducted where filament density was varied above and below the release layer. The lower filament density above or below the release layer provides an effect similar to an additional change in the distance between layers.

1. A three-dimensional fabrication method comprising:
using a processor, identifying an area of a three-dimensional object that requires a support structure;
using a processor, virtually generating a support structure for the three-dimensional object,
using a processor, virtually slicing a scene that includes the support structure and/or the three-dimensional object into layers;
using a processor, identifying an area of any layer where the support structure is adjacent to the three-dimensional object;
depositing, by a first printing apparatus, polymer filaments forming at least one first polymer layer of one of a support structure and/or a three-dimensional object;
depositing, by a second printing apparatus, a layer comprising a release agent on at least a portion of the first polymer layer; and
depositing, by the first printing apparatus, polymer filaments forming at least one second polymer layer of the other of the support structure and/or the three-dimensional object on the layer comprising the release agent,
wherein a filament density of at least one of the support structure or the three-dimensional object is adjusted during the three-dimensional fabrication process.

2. The three-dimensional fabrication method of claim 1, wherein the release agent is an ink deposited through at least one print head of the second printing apparatus.

3. The three-dimensional fabrication method of claim 1, wherein the identified area adjacent the three-dimensional object and the support structure is converted into a two-dimensional image file.

4. The three-dimensional fabrication method of claim 1, wherein the support structure is formed from a polymeric material that is the same as a polymeric material that forms the three-dimensional object.

5. The three-dimensional fabrication method of claim 1, wherein the support structure is formed from a polymeric material that is different from a polymeric material that forms the three-dimensional object.

6. The three-dimensional fabrication method of claim 2, wherein the ink includes at least one ingredient that is soluble in the polymeric material that forms the three-dimensional object.

7. The three-dimensional fabrication method of claim 6, wherein the at least one ingredient of the ink accelerates dissolution of the polymeric material of the support structure.

8. The three-dimensional fabrication method of claim 1, wherein the release agent is formulated with materials selected from the group consisting of silicone oils, oil and hydrocarbons, polyethylene glycols, polypropylene glycols, esters, surfactants, water soluble gums, solid release matter in plasticizer or volatile solvent, low tack adhesive, or combinations thereof.

9. The three-dimensional fabrication method of claim 1, wherein the release agent is based on a non-reactive chemistry, a reactive chemistry release agent, or a phase-change release agent.

10. The three-dimensional fabrication method of claim 1, wherein a space between the support structure and the three-dimensional object is virtually generated during the slicing of the scene.

11. The three-dimensional fabrication method of claim 10, wherein a thickness of the space is between 0.1% and 100% of the first polymer layer thickness.

12. The three-dimensional fabrication method of claim 10, wherein a thickness of the space is about 50% of the first polymer layer thickness.

13. The three-dimensional fabrication method of claim 10, wherein a thickness of the space is adjusted based on curvature of the three-dimensional object.

14. (canceled)

15. The three-dimensional fabrication method of claim 1, wherein the filament density variations are within 0.1 to 2.0 of nominal filament density.

16. The three-dimensional fabrication method of claim 1, further comprising forced cooling of the at least one first polymer layer prior to deposition of the layer comprising the release agent.

17. The three-dimensional fabrication method of claim 16, wherein the at least one first polymer layer is forced cooled by applying ambient or outside air or by applying compressed gas.

18. The three-dimensional fabrication method of claim 1, wherein the three-dimensional object is formed using fused deposition modeling.

19. The three-dimensional fabrication method of claim 1, wherein the layer comprising the release agent includes ultraviolet absorbing dyes or fluorescent dyes.

20. (canceled)

21. A three-dimensional fabrication method comprising:
using a processor, identifying an area of a three-dimensional object that requires a support structure;
using a processor, virtually generating a support structure for the three-dimensional object;
using a processor, virtually slicing a scene that includes the support structure and/or the three-dimensional object into layers;
using a processor, identifying an area of any layer where the support structure is adjacent to the three-dimensional object;
depositing, by a first printing apparatus, polymer filaments forming at least one first polymer layer of one of a support structure and/or a three-dimensional object:
depositing, by a second printing apparatus, a layer comprising a release agent on at least a portion of the first polymer layer, and
depositing, by the first printing apparatus, polymer filaments forming at least one second polymer layer of the other of the support structure and/or three-dimensional object on the layer comprising the release agent.
wherein a concentration of the release agent is adjusted based on curvature of the three-dimensional object.

22. (canceled)

23. (canceled)

24. (canceled)

25. (canceled)

26. The three-dimensional fabrication method of claim 1, wherein the first polymer layer and the second polymer layer are deposited by at least one extruder head of the first printing apparatus.

27. The three-dimensional fabrication method of claim 1, wherein the release agent is a fugitive glue.

28. The three-dimensional fabrication method of claim 1, wherein the release agent comprises at least one ingredient that forms a film on the surface of the first polymer layer.

29. The three-dimensional fabrication method of claim 1, wherein the first polymer layer and the second polymer layers comprise at least one of a single polymer, a copolymer, a polymer mixture, or any combination thereof, and at least one of an inorganic filler or an organic filler
